(19) United States
(12) Patent Application Publication
(10) Pub. No.: US 2006/0164570 A1
(43) Pub. Date: Jul. 27, 2006

(54) Polarizer

(75) Inventors: Heng-Hsien Li, Hsinchu City (TW); Tung-Lung Li, Pingzhen City (TW); Long-Hai Wu, Tucheng City (TW)

Correspondence Address: BRUCE H. TROXELL, Suite 1404, 5205 LEESBURG PIKE, FALLS CHURCH, VA, 22041, US

(73) Assignee: Optimax Technology Corporation

(21) Appl. No.: 11/189,921

(22) Filed: Jul. 27, 2005

(30) Foreign Application Priority Data
Jan. 21, 2005 (TW) 94101747

(51) Int. Cl. G02F 1/1335

(52) U.S. Cl. 349/96

(57) ABSTRACT

A polarizer comprising an optical film and a birefringent film. The optical film reflects light selectively, and the birefringent film formed on the optical film exhibits Nz=(nx−nz)/(nx−ny) in a range from −0.1 to −5.0. The birefringent film is one selected from a group consisting of a polycarbonate, a triacetyl cellulose, a metallocene cycloolefin copolymer, and a polymer material. Therefore, by combining the polarizer in the present invention with a liquid crystal display panel, the problem of color shifts will be overcome and better visual performance will be presented.

### 1. FIELD OF THE INVENTION

The present invention relates to a polarizer and more particularly, a polarizer capable of reducing color shifts of a liquid crystal display (LCD) at a wide viewing angle.

### 2. BACKGROUND OF THE INVENTION

In conventional liquid crystal displays, such as transmission-type and reflection-type, for example, polarizers play a vital role in controlling the light passing through the liquid crystals. However, transmission remarkably decreases while light passes through the polarizers so that the efficiency of light will be limited and become even worse.

In order to overcome the problem described above, a prior art, U.S. Pat. No. 6,160,595, discloses a polarizing technique to obtain brighter performance in a liquid crystal display apparatus. Referring to FIG. 1, a liquid crystal display is disclosed. The liquid crystal display comprises: an edge-lit backlight 91 with a reflector 90; a dichromatic polarizer 92; a quarter wave plate 93; and a liquid crystal panel 94 disposed in order. When light, radiated from the edge-lit backlight 91, passes through the dichromatic polarizer 92, a right handed circularly polarized light and a left handed circularly polarized light will be generated. For example, if the right handed circularly polarized light is transmitted and the left handed circularly polarized light is reflected, the right handed circularly polarized light will be converted into a linear polarized light after exiting the quarter wave plate 93. Meanwhile, the left handed circularly polarized light will be converted into right handed circularly polarized light after it is reflected from a reflector 90. Then the reflected right handed circularly polarized light will pass the dichromatic polarizer 92 again and be converted into the linear polarized light after exiting the quarter wave plate 93.

Although the prior art can enhance brightness of the liquid display and achieve a wide viewing angle, it results in a problem that color shifts occur at the wide viewing angle. Referring to FIG. 2, the drawing illustrates the transmission spectrum of the dichromatic polarizer 92 in FIG. 1. A curve marked 1 in the drawing indicates the transmission spectrum while the viewing angle is 90 degrees, i.e., perpendicular to the dichromatic polarizer 92. At this viewing angle, the transmission rate of the visible light region (400 nm to 780 nm) is almost the same. Therefore, rich color and enhanced brightness will be obtained. However, while the observer viewss the polarizer at an included angle α over 90 degrees, the curve 1 will shift towards the left side of the drawing like another curve 2 illustrated in the FIG. 2. The curve 2 indicates that the region of red light spectrum has a higher transmission rate because red light is less reflected.

To avoid the issue of color shifts, some techniques are proposed to solve this problem. For example in U.S. Pat. No. 5,731,886 entitled “Birefringent Compensator for Reflective Polarizers”, Taber et al. issued Mar. 24, 1998, the invention comprises a circular dichroism material layer and a compensator comprising a uniaxial film with an optical axis perpendicular to the surfaces of the film. The compensator is inserted on the path of light transmitted through the circular dichroism material layer, and incorporated into a brightness enhancement system for a liquid crystal display.

European Patent Application EP 0860717 A2 proposes to improve the viewing angle behavior of the broadband circular polarizers by using compensation films, which are uniaxial and have their optical axes perpendicular to the surfaces. The compensation films typically consist of two layers. The first layer closer to the circular polarizer has a positive birefringence, and the second layer has a negative birefringence. These two-layer compensation films may be inserted in front of and/or at the back of the circular polarizer.

Another method to solve the problem of color shifts is to utilize two compensation films. One has the refractive indices nx, ny and nz with the relation nx>ny=nz, and the other has the refractive indices with the relation nx=ny>nz, where nz is a refractive index of an axis expressing a direction of the thickness d of the compensation films, and nx and ny are in-plane refractive indices of the compensation films respectively.

Because of high manufacturing cost for the prior art listed above, it is necessary to propose a polarizer to solve the problem of the prior art.

### SUMMARY OF THE INVENTION

The main object of the present invention is to utilize a combination of an optical film that reflects light selectively and a birefringent film to form a polarizer so that the problem of color shifts at a wide viewing angle can be solved.

A further object of the present invention is to utilize a combination of an optical film that reflects light selectively and a birefringent film to form a polarizer that is easy to manufacture with low cost.

In order to achieve the foregoing object, the present invention provides a polarizer, comprising: an optical film and a birefringent film. The optical film reflects light selectively, and the birefringent film is formed on the optical film.

It is preferable that the optical film is substantially a liquid crystal material with periodic spiral molecules.

It is preferable that the birefringent film exhibits Nz=(nx−nz)/(nx−ny) in a range from −0.1 to −5.0 where nz is a refractive index of expressing a direction of a thickness of said birefringent film, nx is a refractive index in a direction of slow axis, and ny is a refractive index in a direction of fast axis.

It is preferable that the birefringent film is one selected from a group consisting of a polycarbonate, a triacetyl cellulose, a metallocene cycloolefin copolymer, and a polymer material.

### BRIEF DESCRIPTION OF THE DRAWINGS

The drawings, incorporated into and form a part of the disclosure, illustrate the embodiments and method related to this invention and will assist in explaining the detail of the invention.

FIG. 1 illustrates optical paths of light passing through the dichromatic polarizer disposed in the conventional liquid crystal display;

FIG. 2 shows the transmission spectrum at different viewing angles while light passes through the dichromatic polarizer;

FIG. 3A illustrates a preferred embodiment of the polarizer according to the present invention;

FIG. 3B illustrates directions of the refractive indices (nx, ny, nz) related to the birefringent film of the present invention; and

FIG. 4 illustrates another preferred embodiment of the polarizer according to the present invention being combined with a liquid display device.

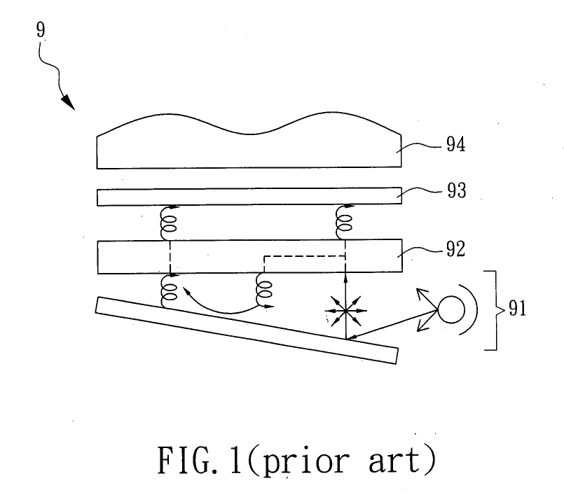

### DESCRIPTION OF THE PREFERRED EMBODIMENT

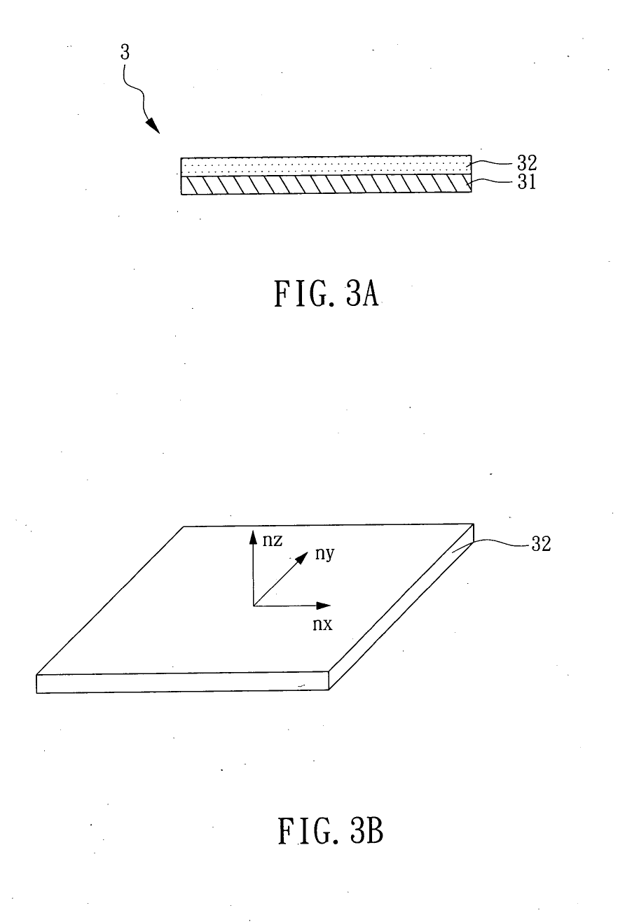

FIG. 3A illustrates a preferred embodiment of a polarizer according to the present invention. The polarizer 3 comprises an optical film 31 that reflects light selectively and a birefringent film 32 formed on the optical film 31. The optical film 31 is substantially a liquid crystal material with periodic spiral molecules. In this embodiment, the birefringent film 32 exhibits Nz=(nx−nz)/(nx−ny) in a range from −0.1 to −5.0. The birefringent film 32 is also capable of absorbing light within a wavelength range that refers to the red light spectrum. In the present embodiment, The wavelength range is from 620 to 780 nanometers.

FIG. 3b illustrates directions of the refractive indices (nx, ny, nz) related to the birefringent film of the present invention. In the expression of Nz stated above, nx referring to the refractive index of extraordinary axis (slow axis) is a largest in-plane refractive index in the birefringent film 32, ny referring to the refractive index of ordinary axis is a refractive index of a plane perpendicular to the plane having the refractive index of nx, and nz is a refractive index of an axis expressing a direction of the thickness of the birefringent film 21.

The birefringent film 32 disclosed in the present invention is a compensation film having a duality that satisfies the relations nx>ny=nz, and nx=ny>nz simultaneously. The birefringent film 32 is one selected from a group consisting of a oolycarbonate, a triacetyl cellulose (TAC), a metallocene cycloolefin copolymer (mCOC), and a polymer material, wherein the polymer material is one selected from a group consisting of a polyethylene (PE) and a polypropylene (PP).

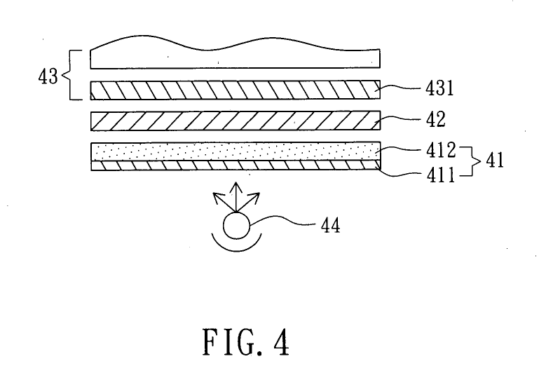

FIG. 4 illustrates another preferred embodiment of the polarizer according to the present invention combined with a liquid display device. In this embodiment, a polarizer 41 according to the present invention is combined with a liquid crystal display 43. The combination comprises the polarizer 41, a quarter wave plate 42, a liquid crystal panel 43, and a backlight device 44.

The polarizer 41 disposed between the backlight device 44 and a rear polarize 431 of the liquid crystal panel 43 comprises an optical film 411 and a birefringent film 412. The optical film 411 reflects light selectively; and the birefringent film 412 is formed on the optical film 411. The quarter wave plate 42 is disposed between the rear polarizer 431 and the polarizer 41. The optical film 411 is substantially a liquid crystal material with periodic spiral molecules that is capable of dividing an unpolarized incident light emitted from the backlight device 44 into a first circularly polarized light transmitted therethrough and a second circularly polarized light reflected thereon.

The birefringent film 412 is one selected from a group consisting of a polycarbonate, a triacetyl cellulose (TAC), a metallocene cycloolefin copolymer (mCOC), and a polymer material, wherein the polymer material is one selected from a group consisting of a poly-ethylene (PE) and a polypropylene (PP). By means of utilizing the material listed above, the birefringent film exhibits Nz=(nx−nz)/(nx−ny) in a range from −0.1 to −5.0, thus capable of absorbing light within a wavelength range. In this embodiment, the wavelength range is from 620 to 780 nanometers, which is the optical wavelength range of the red light spectrum.

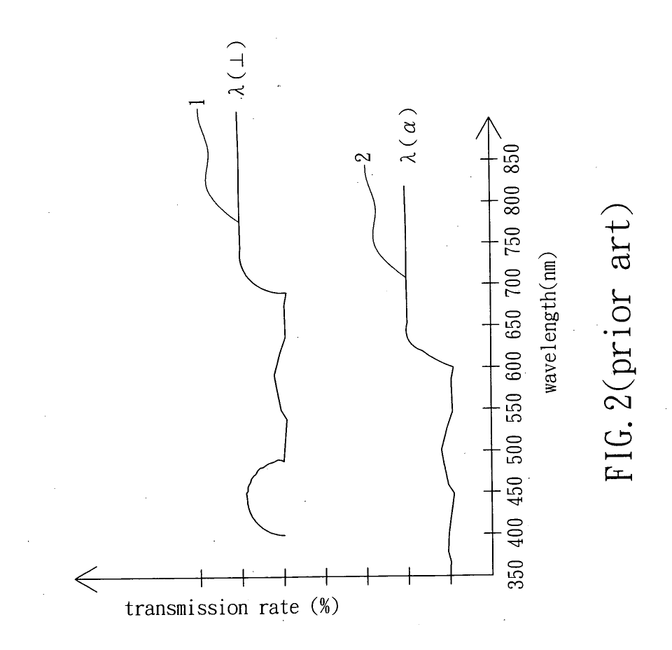

Because the transmitted rate of the red light spectrum is high, as shown in FIG. 2, when the user observes the liquid crystal panel at a wide viewing angle, the color shift problem occurs. This is because a phase retardation effect generated from liquid crystal material disposed in the liquid crystal panel 43 to the incident light occurs with different incident angles of light. The visual performance at the wide viewing angle is not as good as the visual performance at a normal viewing angle. Therefore, with the combination of the polarizer 41 and the liquid crystal panel 43, the problem of color shifts will be overcome to present better visual performance.

While the present invention has been described and illustrated herein with reference to the preferred embodiment thereof, it will be understood by those skilled in the art that various changes in form and details may be made therein without departing from the spirit and the scope of the invention.

What is claimed is:

1. A polarizer, comprising:
an optical film that reflects light selectively; and
a birefringent film formed on said optical film.

2. The polarizer according to claim 1, wherein said optical film is substantially a liquid crystal material with periodic spiral molecules.

3. The polarizer according to claim 1, wherein said birefringent film exhibits Nz=(nx−nz)/(nx−ny) in a range from −0.1 to −5.0,
where nz is a refractive index of an axis expressing a direction of a thickness of said birefringent film, nx is a refractive index in a direction of slow axis, and ny is a refractive index in a direction of fast axis.

4. The polarizer according to claim 1, wherein said birefringent film is one selected from a group consisting of a polycarbonate, a triacetyl cellulose, a metallocene cycloolefin copolymer, and a polymer material.

5. The polarizer according to claim 4, wherein said polymer material is one selected from a group consisting of a polyethylene and a polypropylene.

6. The polarizer according to claim 1, wherein said polarizer is disposed between a rear polarizer of a liquid crystal display and a backlight source to overcome color shift at a wide viewing angle.

7. The polarizer according to claim 6, wherein said optical film is a liquid crystal material that is capable of dividing an unpolarized incident light into a first circularly polarized light transmitted therethrough and a second circularly polarized light reflected thereon.

8. The polarizer according to claim 7, wherein a quarter wave plate is disposed between said rear polarizer and said polarizer.

9. The polarizer according to claim 1, wherein said birefringent film is capable of absorbing light within a wavelength range.

10. The polarizer according to claim 9, wherein said wavelength range is substantially a region of red light.
